(19) United States
(12) Patent Application Publication
(10) Pub. No.: US 2012/0069045 A1
(43) Pub. Date: Mar. 22, 2012

(54) DRAWN IMAGE SHARING APPARATUS

(76) Inventors: Takako Hashimoto, Tokyo (JP); Tadashi Araki, Kanagawa (JP); Keiji Ohmura, Kanagawa (JP); Yuuji Kasuya, Kanagawa (JP); Koubun Sakagami, Kanagawa (JP)

(21) Appl. No.: 13/320,875

(22) PCT Filed: Jun. 8, 2010
(86) PCT No.: PCT/JP10/59992

§ 371 Date: Nov. 16, 2011

(30) Foreign Application Priority Data
Jun. 9, 2009 (JP) 2009-138272
Dec. 25, 2009 (JP) 2009-294388
Apr. 28, 2010 (JP) 2010-103401

(51) Int. Cl. G09G 5/00; G09G 5/02

(52) U.S. Cl. 345/589; 345/625

(57) ABSTRACT

A drawn image sharing apparatus for allowing images drawn on plural drawing objects to be shared among the drawing objects includes an image receive unit configured to receive an image transmitted from one or more other drawn image sharing apparatuses; an image display unit configured to display the image received by the image receive unit on a drawing object; a shared area image acquiring unit configured to acquire an image of a shared area of the image displayed by the image display unit; a difference image generating unit configured to generate a difference image indicating a difference in the shared area between the image displayed by the image display unit and the image acquired by the shared area image acquiring unit; and an image transmit unit configured to transmit the difference image to the one or more other drawn image sharing apparatuses.

### TECHNICAL FIELD

The present invention generally relates to a drawn image sharing apparatus, and particularly to a drawn image sharing apparatus capable of allowing images drawn on plural objects to be shared among the objects.

### BACKGROUND ART

A remote conferencing system is known in which characters or figures (which may be hereafter referred to as “images”) drawn on objects, such as whiteboards or blackboards (which may be hereafter referred to as “drawing objects”) installed at separate locations are captured with an image-capturing device, such as a camera, so that the images can be projected onto each drawing object using a projecting device, such as a projector. In this way, the images drawn on the plural drawing objects can be displayed on each of the drawing objects, thus allowing the images to be shared by people at the various locations. In other words, the system allows the images drawn on the plural drawing objects to be composed into a single image that can be displayed on each of the drawing objects, using the projecting device, which is an image forming device, and the image-capturing device.

Japanese Laid-Open Patent Application No. 2005-203886 discusses a remote conference supporting system in which a projector for projecting an image and a server for transmitting an original image to the projector are provided at each of multiple remote locations. The projector is equipped with an image-capturing unit configured to capture an image projected on a screen, and a transmit unit configured to transmit the captured image to the server. The server includes a composing unit configured to compose an image received from one projector with the original image, and a forwarding unit configured to forward a resultant composed image to another projector.

However, in this related technology, projection of the image on the screen by the projector needs to be interrupted at certain time intervals in order to capture the projected image, thus adversely affecting the visibility of the image displayed on the screen (drawing object).

### SUMMARY OF THE INVENTION

The disadvantages of the prior art are overcome by the present invention which, in one aspect, is a drawn image sharing apparatus for allowing images drawn on plural drawing objects to be shared among the drawing objects. The apparatus includes an image receive unit configured to receive an image transmitted from one or more other drawn image sharing apparatuses; an image display unit configured to display the image received by the image receive unit on a drawing object; a shared area image acquiring unit configured to acquire an image of a shared area of the image displayed by the image display unit; a difference image generating unit configured to generate a difference image indicating a difference in the shared area between the image displayed by the image display unit and the image acquired by the shared area image acquiring unit; and an image transmit unit configured to transmit the difference image to the other drawn image sharing apparatus.

In another aspect, the invention provides a drawn image sharing apparatus for allowing images drawn on plural drawing objects to be shared among the drawing objects using an image forming device and an image-capturing device. The apparatus includes an image receive unit configured to receive an image transmitted from one or more other drawn image sharing apparatuses; an image supply unit configured to supply the image received by the image receive unit to the image forming device in order to form the image on a drawing object; a captured image acquiring unit configured to acquire a captured image of a shared area of the image formed on the drawing object; a difference image generating unit configured to generate a difference image indicating a difference in the shared area between the image formed by the image forming device and the image captured by the image-capturing device; and an image transmit unit configured to transmit the difference image to the one or more other drawn image sharing apparatuses.

In another aspect, the invention provides a drawn image sharing system for allowing images drawn on plural drawing objects to be shared among the drawing objects, in which system a drawn image sharing apparatus is allocated to each drawing object. The drawn image sharing apparatus includes an image receive unit configured to receive an image transmitted from one or more other drawn image sharing apparatuses; an image display unit configured to display the image received by the image receive unit on the corresponding drawing object; a shared area image acquiring unit configured to acquire an image of a shared area of the image displayed on the corresponding drawing object; a difference image generating unit configured to generate a difference image indicating a difference in the shared area between the image displayed by the image display unit and the image acquired by the shared area image acquiring unit; and an image transmit unit configured to transmit the difference image to the one or more other drawn image sharing apparatuses.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram of a drawn image sharing system according to an embodiment of the present invention;

FIG. 2 is a block diagram of a hardware configuration of a drawn image sharing apparatus;

FIG. 3 is a functional block diagram of the drawn image sharing apparatus;

FIG. 4 illustrates a shared area of images exchanged with a plurality of drawn image sharing apparatuses according to an embodiment of the present invention;

FIG. 5 is a flowchart of a shared image receiving operation of a drawn image sharing apparatus according to an embodiment of the present invention;

FIG. 6 is a flowchart of a captured image receiving operation of a drawn image sharing apparatus according to an embodiment of the present invention;

FIG. 7 conceptually illustrates an operation of a drawn image sharing system according to an embodiment of the present invention;

FIG. 8 is a flowchart of a difference image generating process in the captured image receiving operation illustrated in FIG. 6;

FIG. 9 is a flowchart of an average difference calculating process in the difference image generating process illustrated in FIG. 8;

FIG. 10 is a flowchart of a difference image calculating process in the difference image generating process illustrated in FIG. 8; and

FIG. 11 is a block diagram of a drawn image sharing system according to an embodiment of the present invention.

### BEST MODE OF CARRYING OUT THE INVENTION

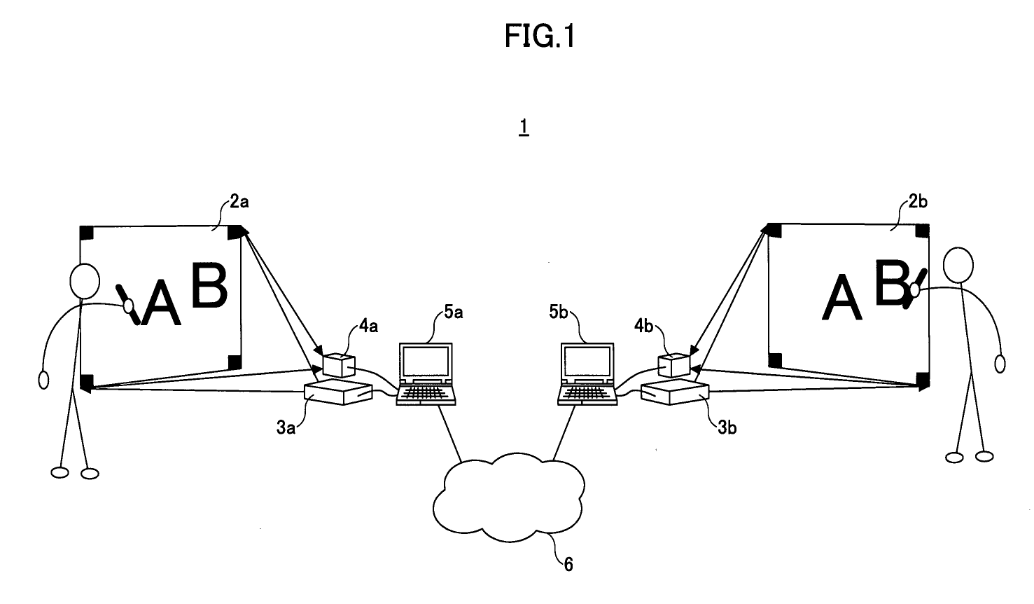

FIG. 1 illustrates a drawn image sharing system 1 according to an embodiment of the present invention. The drawn image sharing system 1 includes a whiteboard 2a (drawing object), a projecting device 3a, an image-capturing device 4a, and a drawn image sharing apparatus 5a, which are installed at one location, such as in a conference room. The drawn image sharing system 1 also includes a whiteboard 2b (drawing object), a projecting device 3b, an image-capturing device 4b, and a drawn image sharing apparatus 5b, which are installed at another location, such as in another conference room. The whiteboards 2a and 2b may be hereafter referred to collectively as a “whiteboard 2”. The projecting devices 3a and 3b may be hereafter collectively referred to as a “projecting device 3”. The image-capturing devices 4a and 4b may be hereafter collectively referred to as an “image-capturing device 4”. The drawn image sharing apparatuses 5a and 5b may be hereafter collectively referred to as a “drawn image sharing apparatus 5”. Preferably, the drawing object may include a blackboard or a sheet of paper.

The projecting device 3, which may include a conventional projector, is configured to project an image transmitted from one drawn image sharing apparatus 5 onto the whiteboard 2 corresponding to the other drawn image sharing apparatus 5. The projecting device 3 may be installed such that a projected area is included in a drawing region of the whiteboard 2. The projecting device 3 is an example of an image forming device. Preferably, the image forming device may be provided by a display unit, such as a liquid crystal display unit of the drawn image sharing apparatus 5. When such a display unit is used as an image forming device in an embodiment of the present invention, a light-transmitting board may be mounted on a display surface of the display unit as a drawing object on which an image, such as a letter or a figure, can be drawn.

While in the embodiment illustrated in FIG. 1 the drawing region of the whiteboard 2 is identical to the projected area of the projecting device 3, a part of the drawing region of the whiteboard 2 may be used as the projected area of the projecting device 3.

The image-capturing device 4, which may include a conventional video camera, is configured to capture the whiteboard 2 at preset time intervals, such as every 0.5 second or 15 times per second. The image-capturing device 4 then transmits captured images of the whiteboard 2 to the drawn image sharing apparatus 5. The image-capturing device 4 may be installed so that it can capture the entire projected area of the projecting device 3.

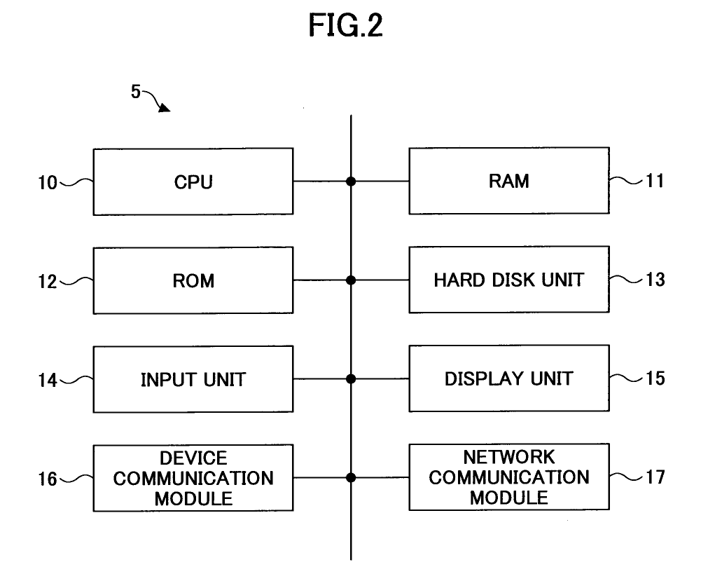

FIG. 2 illustrates a hardware structure of the drawn image sharing apparatus 5, which may be provided by a conventional computer. The hardware structure includes a central processing unit (CPU) 10; a random access memory (RAM) 11; a read-only memory (ROM) 12; a hard disk unit 13; an input device 14 which may include a keyboard and a pointing device; a display unit 15 such as a liquid crystal display unit; a device communication module 16 configured to enable communications with peripheral devices such as the projecting device 3 and the image-capturing device 4; and a network communication module 17 configured to enable communications with an external device, such as another drawn image sharing apparatus 5, via a network 6, such as the Internet or a dedicated line. As mentioned above, the display unit 15 may provide an image forming device for forming an image of a letter, a figure, etc., transmitted from the other drawn image sharing apparatus 5 on the drawing object, such as a light-transmitting board, in an embodiment of the present invention.

The ROM 12 and the hard disk unit 13 may be configured to store a program for causing a computer apparatus to function as the drawn image sharing apparatus 5. In this case, the computer apparatus may function as the drawn image sharing apparatus 5 when the program stored in the ROM 12 or the hard disk unit 13 is executed by the CPU 10 using the RAM 11 as a working area.

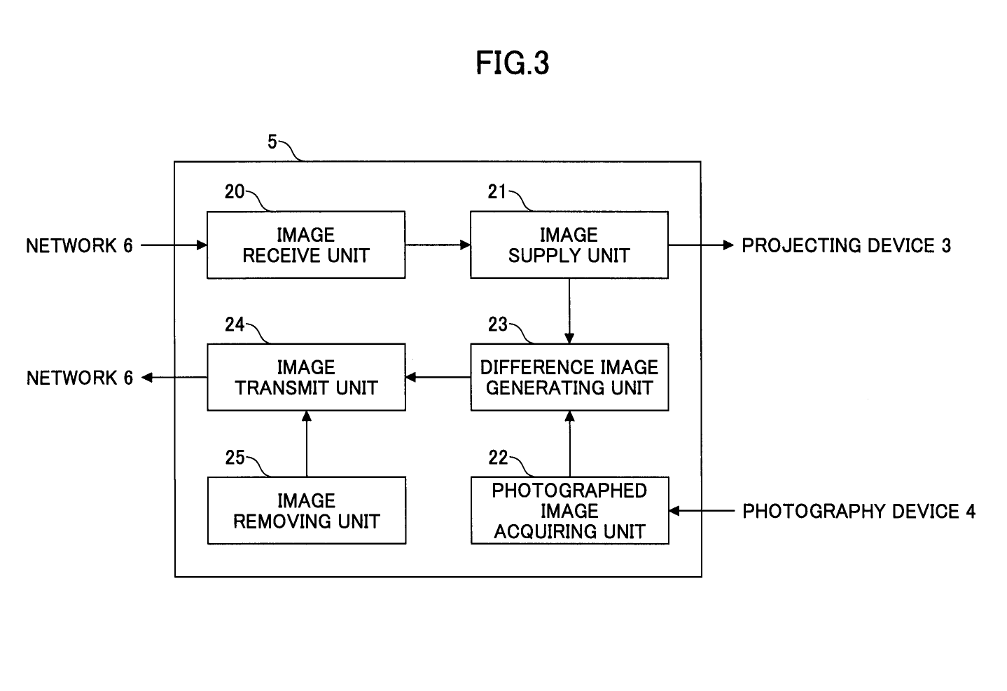

FIG. 3 illustrates a functional structure of the drawn image sharing apparatus 5. The functional structure includes an image receive unit 20 configured to receive an image from another drawn image sharing apparatus 5; an image supply unit 21 configured to supply the image received by the image receive unit 20 to the projecting device 3 for projection on the whiteboard 2; a captured image acquiring unit 22 configured to acquire from the image-capturing device 4 a captured image of a shared area of the image projected on the whiteboard 2; a difference image generating unit 23 configured to generate a difference image representing a difference in the shared area between the image projected by the projecting device 3 and the image captured by the image-capturing device 4; an image transmit unit 24 configured to transmit the difference image to another drawn image sharing apparatus 5; and an image removing unit 25 configured to remove an unwanted image that is not to be displayed on the whiteboard 2 from an image displayed on the whiteboard 2.

The image receive unit 20 and the image transmit unit 24 may be provided by the CPU 10 and the network communication module 17. The image supply unit 21 and the captured image acquiring unit 22 may be provided by the CPU 10 and the device communication module 16. The difference image generating unit 23 and the image removing unit 25 may be provided by the CPU 10.

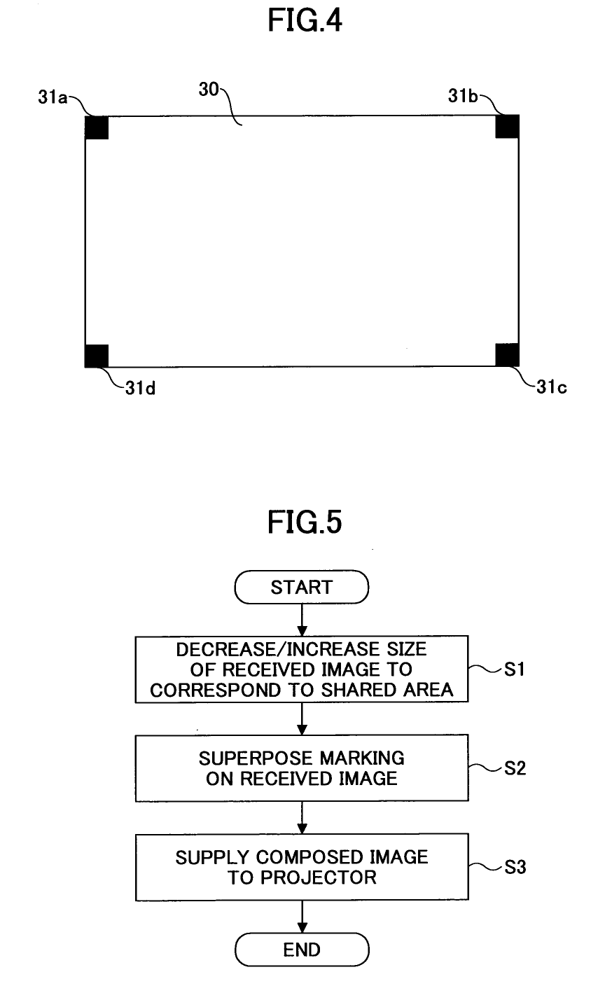

The image supply unit 21, which may be provided by an image display unit, may be configured to superpose marker images 31a through 31d on an image supplied to the projecting device 3 in order to specify a shared area 30, as illustrated in FIG. 4. In the embodiment illustrated in FIG. 4, the marker images 31a through 31d are rectangular and disposed at the four corners of the shared area 30. However, the shape and number of the marker images 31a through 31d may be different from those illustrated in FIG. 4 as long as they can specify the shared area 30.

The captured image acquiring unit 22, which may be referred to as a “shared area image acquiring unit”, may be configured to delimit the shared area 30 based on the positions of the marker images 31a through 31d in the image acquired from the image-capturing device 4, after performing an image correction, such as keystone correction, on the image. Thus, the shared area 30 can be uniquely defined regardless of the projected area, thus allowing images exchanged between the drawn image sharing apparatuses 5 to be accurately aligned with the shared area 30.

The image supply unit 21 may be configured to increase or decrease the size of the image received by the image receive unit 20 so that the area of the received image is identical to the shared area 30 of the image supplied to the projecting device 3, before supplying the received image to the projecting device 3.

The difference image generating unit 23 is configured to generate a difference image representing a difference between the image supplied from the image supply unit 21 to the projecting device 3 and the image captured by the image-capturing device 4 in the shared area 30. Specifically, the difference image generating unit 23 may generate the difference image by comparing the images on a pixel by pixel basis. For example, the difference image may consist of pixels whose absolute values of differences in illuminance between corresponding pixels or whose distance in a color space between the corresponding pixels are greater than a predetermined threshold.

Preferably, the difference image generating unit 23 may be configured to generate the difference image by comparing the image supplied to the projecting device 3 and the image captured by the image-capturing device 4 on a rectangular unit (such as 8 pixels×8 pixels) basis. In this case, the difference image may consist of rectangles whose absolute values of differences in illuminance between corresponding rectangles, or whose average values of distance between the corresponding rectangles in a color space are greater than a predetermined threshold.

Preferably, the difference image generating unit 23 may be configured to generate the difference image after performing a filtering process on the image supplied to the projecting device 3 and on the image captured by the image-capturing device 4. For example, the difference image generating unit 23 performs a sharpening filtering process on the image captured by the image-capturing device 4 and a smoothing filtering process and further a sharpening filtering process on the image supplied to the projecting device 3, before generating the difference image from the thus filtered images. The sharpening filtering process may involve extracting a difference between an original image and a moving average image obtained by averaging each pixel of the captured image using surrounding pixels.

The difference image generating unit 23 may perform the smoothing filtering process by providing a thickening process on the image supplied to the projecting device 3 using erosion that is a fundamental morphological operation. Thus, the difference image generating unit 23 can reduce the influence of keystone distortion or position error and the like that could not be sufficiently corrected by the captured image acquiring unit 22.

Preferably, the difference image generating unit 23 may perform a filtering process on the generated difference image. For example, the difference image generating unit 23 may include a filter configured to remove at least one of color components of yellow-green and yellow from the generated difference image. In this way, the difference image generating unit 23 can remove from the difference image yellow-green and/or yellow bright lines which may be contained in a light source of the projecting device 3.

The image transmit unit 24 is configured to transmit the difference image generated by the difference image generating unit 23 to another drawn image sharing apparatus 5. When the difference image generated by the difference image generating unit 23 is empty (i.e., when there is no difference between the compared images), or when the difference image is identical to a previously transmitted difference image, the image transmit unit 24 may not transmit the difference image. Specifically, the image transmit unit 24 may be configured to store a difference image in a recording medium, such as the RAM 11, when transmitting the difference image to another drawn image sharing apparatus 5, so that a subsequent difference image can be compared with the previous difference image stored in the recording medium.

When a difference image is generated by the difference image generating unit 23, an unwanted image (so-called “garbage”) may be projected on the whiteboard 2 by the projecting device 3 due to the timing of drawing on the whiteboard 2 or the influence of transmission delay in the network 6, for example, even though there is no image drawn on any of the whiteboards 2.

The image removing unit 25 is configured to perform an image resetting process in order to remove such an unwanted image from the image displayed on the whiteboard 2. The image removing unit 25 may be configured to perform the image resetting process by causing the image transmit unit 24 to transmit a white image corresponding to the background color of the whiteboard 2.

Thus, in the image resetting process, only an image that should be displayed on the whiteboard 2 is received as a difference image from the other drawn image sharing apparatus 5, so that an image from which the unwanted image is removed can be projected onto the whiteboard 2. Further, a difference image is generated by the difference image generating unit 23 based on a captured image of a shared area of the whiteboard 2, and the difference image is then transmitted to the other drawn image sharing apparatus 5. Thus, an image from which the unwanted image has been removed can also be projected for the other drawn image sharing apparatus 5.

The image removing unit 25 may be configured to perform the image resetting process in response to a request made via the input device 14, or at certain time intervals (such as 10 seconds). Alternatively, the image removing unit 25 may be configured to analyze an image acquired by the captured image acquiring unit 22 in order to perform the image resetting process when an image representing an obstacle, such as a person drawing on the whiteboard 2, has moved out of the shared area. Further alternatively, the image removing unit 25 may be configured to analyze the difference image generated by the difference image generating unit 23 in order to perform the image resetting process when an image representing the obstacle has moved out of the shared area. Further alternatively, the image removing unit 25 may be configured to analyze an image supplied from the image supply unit 21 to the projecting device 3 in order to perform the image resetting process when an image representing the obstacle has moved out of the shared area.

An operation of the drawn image sharing apparatus 5 is described with reference to FIGS. 5 through 7. FIG. 5 is a flowchart of a shared image receiving operation of the drawn image sharing apparatus 5. The shared image receiving operation may be started upon reception of an image by the image receive unit 20 from another drawn image sharing apparatus 5, as described below.

First, the size of the image received by the receive unit 20 is increased or decreased by the image supply unit 21 until the area of the received image corresponds to the shared area of an image supplied to the projecting device 3 (step S1). Then, a marker image is superposed on the received image by the image supply unit 21 (step S2), and the received image with the superposed marker image is supplied to the projecting device 3 (step S3). The image supplied to the projecting device 3 is then projected onto the whiteboard 2.

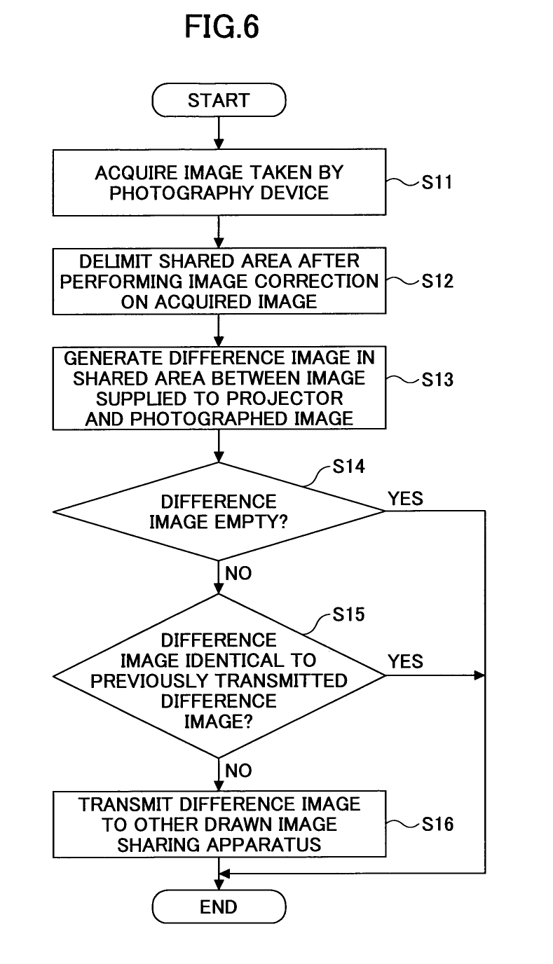

FIG. 6 is a flowchart of a captured image receiving operation of the drawn image sharing apparatus 5. The captured image receiving operation may be started upon capturing of an image by the image-capturing device 4, as described below. First, the image captured by the image-capturing device 4 is acquired by the captured image acquiring unit 22 (step S11). The acquired image is then subjected to image correction, such as keystone correction based on the position of the marker image included in the image, and thereafter a shared area is delimited (step S12). Then, the difference image generating unit 23 generates a difference image representing a difference in the shared area between the image supplied from the image supply unit 21 to the projecting device 3 and the image captured by the image-capturing device 4 (step S13). Thereafter, the image transmit unit 24 determines whether the difference image generated by the difference image generating unit 23 is empty (step S14). When it is determined that the difference image is empty, the captured image receiving operation ends.

On the other hand, when it is determined that the difference image is not empty, the image transmit unit 24 determines whether the difference image is identical to a previously transmitted difference image (step S15). When it is determined that the difference image is identical to the previously transmitted difference image, the captured image receiving operation ends. On the other hand, when it is determined that the difference image is not identical to the previously transmitted difference image, the current difference image is transmitted by the difference image generating unit 23 to the other drawn image sharing apparatus 5 (step S16).

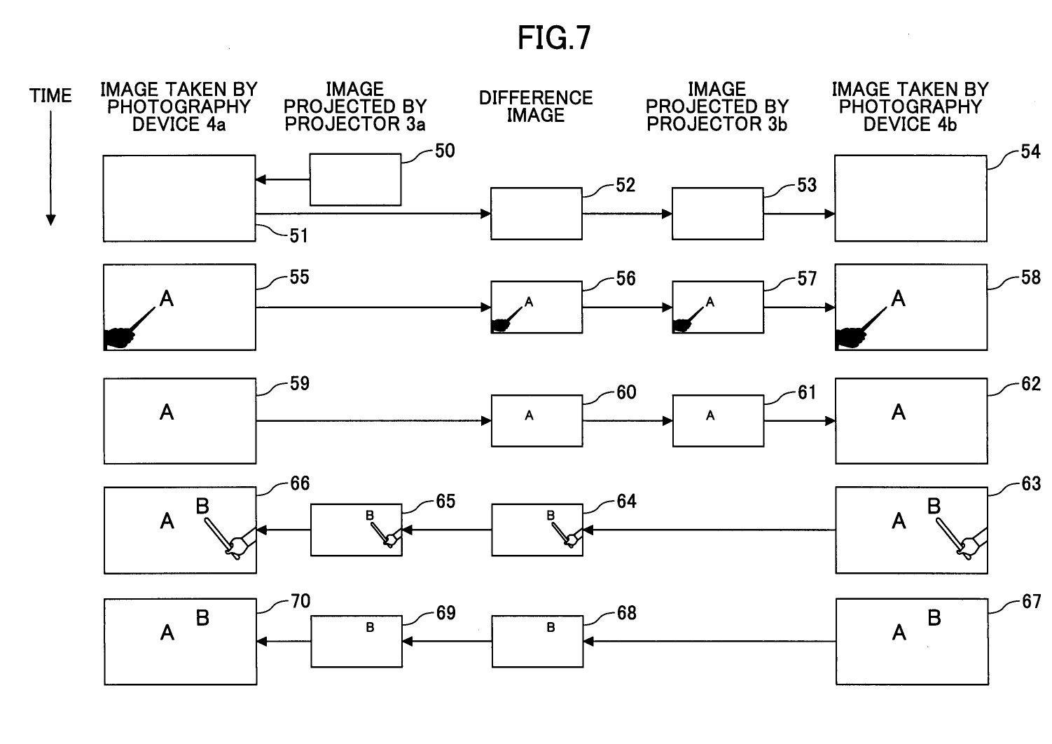

FIG. 7 is a block diagram conceptually illustrating an operation of the drawn image sharing system 1. Specifically, FIG. 7 illustrates difference images exchanged between two locations where the drawn image sharing apparatuses 5a and 5b are installed; images projected by the projecting devices 3a and 3b; and images captured by the image-capturing devices 4a and 4b, in chronological order (from top to bottom).

Upon establishment of a session between the drawn image sharing apparatuses 5a and 5b, a captured image on either the drawn image sharing apparatus 5a or 5b end is transmitted to the other drawn image sharing apparatus as a difference image. In the illustrated example of FIG. 7, initially a vacant projected image 50 is projected by the projecting device 3a onto the whiteboard 2a, and then an image 51 is captured by the image-capturing device 4a. The captured image 51 is then transmitted from the drawn image sharing apparatus 5a to the drawn image sharing apparatus 5b as a difference image 52.

Thus, a vacant projected image 53 is projected by the projecting device 3b onto the whiteboard 2b, and an image 54 is captured by the image-capturing device 4b. Because there is no difference between the projected image 53 and the captured image 54, i.e., the difference image is empty, no difference image is transmitted by the drawn image sharing apparatus 5b.

Then, a letter “A” is drawn in a shared area of the whiteboard 2a, and an image 55 showing the letter “A” and a hand drawing the letter is captured by the image-capturing device 4a. Thus, a difference image 56 between the projected image 50 and the captured image 55 is transmitted from the drawn image sharing apparatus 5a to the drawn image sharing apparatus 5b.

Thus, an image 57 is projected by the projecting device 3b onto the whiteboard 2b, and an image 58 showing the letter “A” and the hand drawing the letter is captured by the image-capturing device 4b. Because there is no difference between the projected image 57 and the captured image 58, i.e., the difference image is empty, no difference image is transmitted by the drawn image sharing apparatus 5b.

The obstacle (the hand) is then removed from the shared area of the whiteboard 2a, and an image 59 showing the letter “A” alone is captured by the image-capturing device 4a. Then, a difference image 60 between the projected image 50 and the captured image 59 is transmitted from the drawn image sharing apparatus 5a to the drawn image sharing apparatus 5b.

Thus, an image 61 showing the letter “A” alone is projected by the projecting device 3b onto the whiteboard 2b, and then an image 62 is captured by the image-capturing device 4b. Because there is no difference between the projected image 61 and the captured image 62, i.e., the difference image is empty, no difference image is transmitted by the drawn image sharing apparatus 5b.

Subsequently, another letter “B” is drawn in the shared area on the whiteboard 2b, and an image 63 showing the letters “A”, “B”, and a hand drawing the letter “B” is captured by the image-capturing device 4b. Then, a difference image 64 between the projected image 61 and the captured image 63 is transmitted from the drawn image sharing apparatus 5b to the drawn image sharing apparatus 5a.

Thus, an image 65 showing the letter “B” and the hand drawing the letter is projected by the projecting device 3a onto the whiteboard 2a, and an image 66 is captured by the image-capturing device 4a. Because the difference image between the projected image 65 and the captured image 66 is identical to the previously transmitted difference image 60, no difference image is transmitted by the drawn image sharing apparatus 5a.

When the obstacle (the hand) is removed from the shared area on the whiteboard 2b, an image 67 is captured by the image-capturing device 4b. Then, a difference image 68 between the projected image 61 and the captured image 67 is transmitted from the drawn image sharing apparatus 5b to the drawn image sharing apparatus 5a.

Thus, an image 69 showing the letter “B” is projected by the projecting device 3a onto the whiteboard 2a, and an image 70 showing the letters “A” and “B” is captured by the image-capturing device 4a. Because the difference image between the projected image 69 and the captured image 70 is identical to the previously transmitted difference image 60, no difference image is transmitted by the drawn image sharing apparatus 5a.

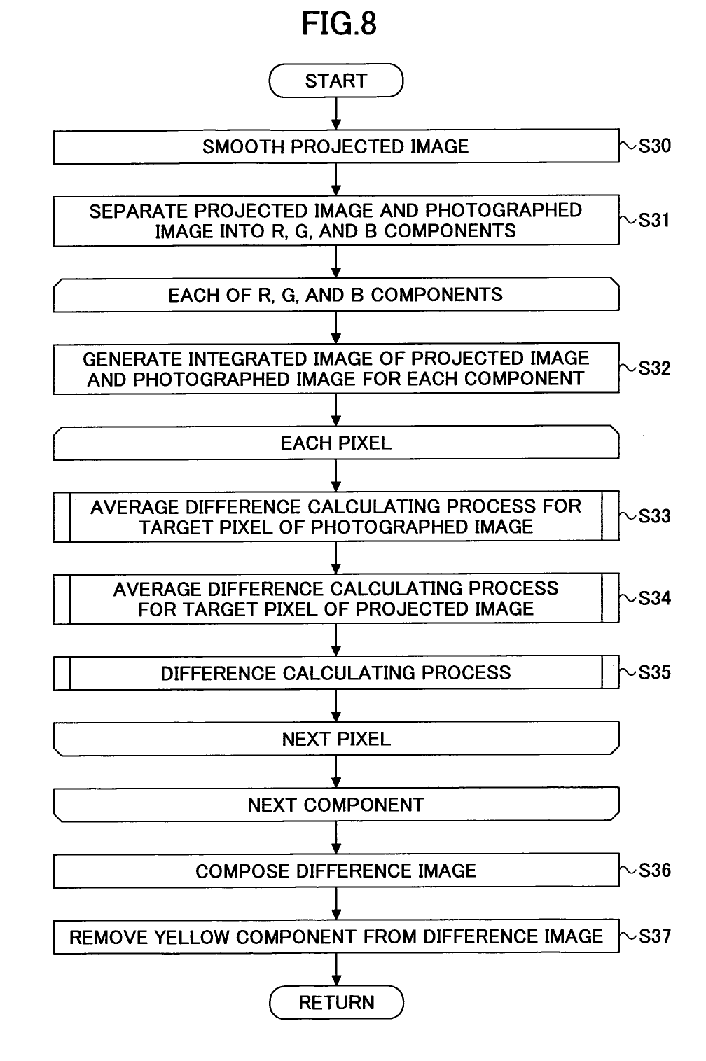

Next, the difference image generating process (step S13) in the captured image receiving operation of the drawn image sharing apparatus 5 illustrated in FIG. 6 is described with reference to FIGS. 8 through 10. In the difference image generating process, the difference image generating unit 23 performs a filtering process on an image captured by the image-capturing device 4 (“captured image”), an image supplied to the projecting device 3 (“projected image”), and a difference image generated on the basis of the captured image and the projected image.

First, the difference image generating unit 23 performs a smoothing filtering process including a thickening process on the projected image (step S30). Then, the difference image generating unit 23 separates each of the smoothed projected image and the captured image into red (R), green (G), and blue (B) components (step S31).

Next, steps S32 through S35 are performed on each of the R, G, and B components as described below. The R, G, and B components may take values from 0 to 255. Illuminance increases as the value increases. Thus, when the values of the R, G, and B components are 0, the color of a corresponding pixel is black. When the values of the R, G, and B components are 255, the color of a corresponding pixel is white.

In step S32, an integrated image of the projected image and the captured image is generated for each component by the difference image generating unit 23.

Then, steps S33 through S35 are performed on each pixel of the captured image and the projected image, as described below. First, an average difference calculating process is performed by the difference image generating unit 23 whereby an average difference of a target pixel of the captured image is calculated by averaging the value of each component of the target pixel with the values of corresponding components of the pixels surrounding the target pixel (step S33).

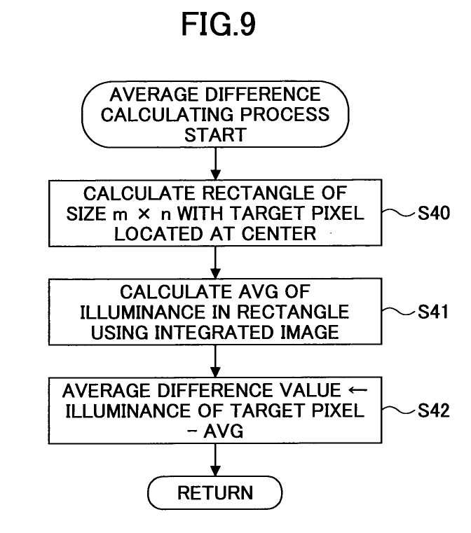

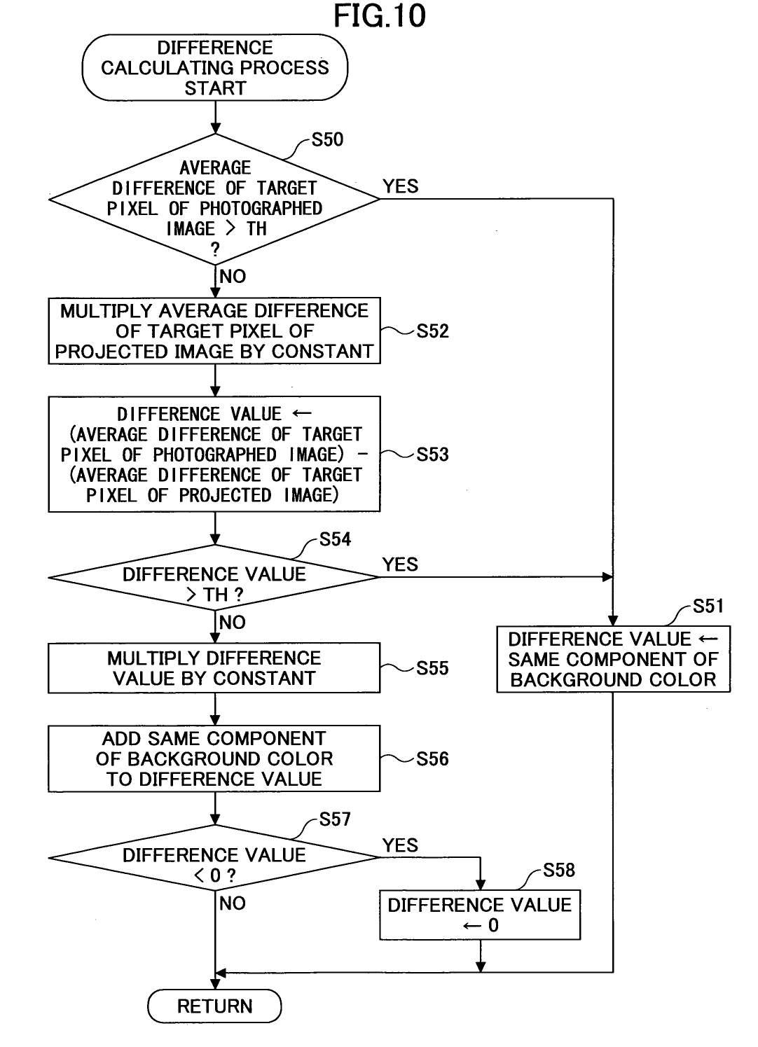

The average difference calculating process is described with reference to FIG. 9. First, the difference image generating unit 23 calculates a rectangle of m×n with a target pixel located at the center, where m and n are predetermined constants, such as m=n=31 pixels when the size of a captured image is 1024 pixels×768 pixels (step S40).

Next, the difference image generating unit 23 calculates an average value of illuminance in the rectangle calculated in step S40, using the integrated image calculated in step S32 (see FIG. 8)(step S41). Specifically, an average value AVG of illuminance in the rectangle may be calculated according to the following equation:

AVG=(RB−RT−LB+LT )/PN

where LT, RT, LB, and RB are illuminance at upper-left, upper-right, lower-left, and lower-right of the rectangle of the integrated image, and PN is the number of pixels in the rectangle. The difference image generating unit 23 subtracts the average value AVG from the illuminance of the target pixel, thus calculating an average difference of the target pixel (step S42) and ending the average difference calculating process.

Referring to FIG. 8, when the average difference calculating process for the target pixel of the captured image ends, the difference image generating unit 23 next performs the average difference calculating process on a target pixel of the projected image, as described with reference to FIG. 9 (step S34). Next, based on the average difference of the target pixel of the captured image and the average difference of the target pixel of the projected image, the difference image generating unit 23 performs a difference calculating process in order to calculate a difference value between the target pixels (step S35).

In the difference calculating process, as illustrated in FIG. 10, first the difference image generating unit 23 determines whether the average difference of the target pixel of the captured image is greater than a predetermined threshold TH (step S50). The value of the threshold TH may be −5. When it is determined that the average difference is greater than the threshold TH, a difference value for a component is set to be the value of the corresponding component of a background color (step S51), and the difference calculating process ends. On the other hand, when it is determined that the average difference is not greater than the threshold TH, the average difference of the target pixel of the projected image is multiplied by a constant (such as 1.5) by the difference image generating unit 23 (step S52) to increase the density of the target pixel.

Next, the difference image generating unit 23 subtracts the multiplied average difference of the target pixel of the projected image from the average difference of the target pixel of the captured image (step S53). Then, the difference image generating unit 23 determines whether a resultant difference value is greater than the threshold TH (step S54). When it is determined that the difference value is greater than the threshold TH, it can be judged that the target pixel of the captured image represents noise due to external light and the like brighter than the background. Thus, the difference image generating unit 23 sets the difference value to be the same value as the value of a corresponding component of the background color (step S51), and the difference calculating process ends.

On the other hand, when it is determined that the difference value is not greater than the threshold TH, the difference image generating unit 23 multiplies the difference value by a constant (such as 1.5) to increase the density of the target pixel (step S55), and then adds the value of the corresponding component of the background color to the difference value (step S56). In accordance with the present embodiment, each component of the background color has a value of 200.

Next, the difference image generating unit 23 determines whether the difference value is less than zero. When it is determined that the difference value is less than zero, the difference value is set to zero (step S58), and the difference calculating process ends. On the other hand, when it is determined that the difference value is not less than zero, the difference calculating process ends.

Referring to FIG. 8, after the above-described process is performed on the R, G, and B components of each pixel of the captured image and the projected image, the difference image generating unit 23 composes a difference image of pixels having the difference values of the R, G, and B components (step S36).

Finally, the difference image generating unit 23 performs a filtering process on the difference image in order to remove a yellow component (step S37). For example, when min(Ir, Ig)>Ib where Ir, Ig, and Ib are the illuminance of the R, G, and B components, respectively, of each pixel of the difference image, the yellow component is removed from the pixel by setting Ib=min(Ir, Ig).

While in the foregoing embodiment, the difference image generating unit 23 performs the filtering process in step S37 whereby the yellow component is removed from the difference image, the difference image generating unit 23 may perform a filtering process for removing a yellow-green component, or the yellow component and the yellow-green component, from the difference image.

As described above, in the drawn image sharing system 1 according to an embodiment of the present invention, a first drawn image sharing apparatus 5 at a first location transmits an image to a second drawn image sharing apparatus 5 at a second location for projection by the projecting device 3 at the second location. The second drawn image sharing apparatus 5 generates a difference image representing a difference between the received image and an image captured by the image-capturing device 4 at the second location and transmits the generated difference image to the first drawn image sharing apparatus 5. Thus, an image drawn on the whiteboard 2 at the first location can be transmitted to the second location without interrupting a projecting operation of the projecting device 3 at the first location. In this way, images drawn on plural whiteboards 2 can be shared among the whiteboards 2 at the separate locations without adversely affecting the visibility of the images displayed on the whiteboards 2.

The drawn image sharing system 1 may employ a conventional projector as the projecting device 3, and a conventional video camera as the image-capturing device 4. The drawn image sharing apparatus 5 may be provided by a conventional computer device. Thus, hardware cost can be reduced.

While in the foregoing embodiment of the present invention, images drawn on the whiteboards 2a and 2b are shared among the whiteboards 2a and 2b using the two drawn image sharing apparatuses 5a and 5b, images drawn on three or more whiteboards may be shared among the whiteboards using three or more drawn image sharing apparatuses. In this case, the image supply unit 21, upon reception of an image from any of the drawn image sharing apparatuses 5, may be configured to store the received image in a recording medium, such as the RAM 11, in association with the transmitting drawn image sharing apparatus 5 after increasing or decreasing the size of the received image as described above. The image supply unit 21 may then compose the stored reception images associated with the respective drawn image sharing apparatuses 5, and supply a resultant composed image to the projecting device 3.

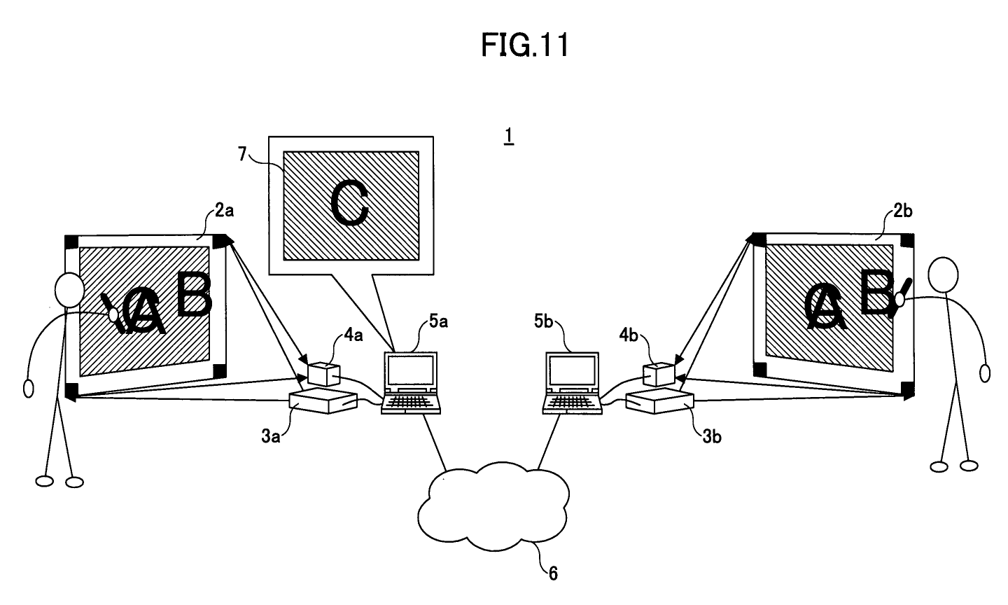

Referring to FIG. 11, in a preferred embodiment of the present invention, image data representing an image 7 may be stored in a recording medium such as the hard disk unit 13, so that the image supply unit 21 can superpose the image 7 on an image supplied to the projecting device 3. In this way, not only the images drawn on the whiteboards 2 but also an image represented by electronic data can be shared among the whiteboards 2.

Although this invention has been described in detail with reference to certain embodiments, variations and modifications exist within the scope and spirit of the invention as described and defined in the following claims.

The present application is based on Japanese Priority Applications No. 2009-138272 filed Jun. 9, 2009, No. 2009-294388 filed Dec. 25, 2009, and No. 2010-103401 filed Apr. 28, 2010, the entire contents of which are hereby incorporated by reference.

1. A drawn image sharing apparatus for allowing images drawn on plural drawing objects to be shared among the drawing objects, comprising:
an image receive unit configured to receive an image transmitted from one or more other drawn image sharing apparatuses;
an image display unit configured to display the image received by the image receive unit on a drawing object;
a shared area image acquiring unit configured to acquire an image of a shared area of the image displayed by the image display unit;
a difference image generating unit configured to generate a difference image indicating a difference in the shared area between the image displayed by the image display unit and the image acquired by the shared area image acquiring unit; and
an image transmit unit configured to transmit the difference image to the one or more other drawn image sharing apparatuses.

2. The drawn image sharing apparatus according to claim 1, wherein the image display unit includes an image supply unit configured to supply the image received from the one or more other drawn image sharing apparatuses to an image forming device configured to form the received image on the drawing object.

3. The drawn image sharing apparatus according to claim 1, wherein the shared area image acquiring unit includes a captured image acquiring unit configured to cause an image-capturing device to capture the image displayed by the image display unit in order to acquire the image of the shared area.

4. A drawn image sharing apparatus for allowing images drawn on plural drawing objects to be shared among the drawing objects using an image forming device and an image-capturing device,
comprising:
an image receive unit configured to receive an image transmitted from one or more other drawn image sharing apparatuses;
an image supply unit configured to supply the image received by the image receive unit to the image forming device in order to form the received image on a drawing object;
a captured image acquiring unit configured to acquire a captured image of a shared area of the image formed on the drawing object from the image-capturing device;
a difference image generating unit configured to generate a difference image indicating a difference in the shared area between the image formed by the image forming device and the captured image; and
an image transmit unit configured to transmit the difference image to the one or more other drawn image sharing apparatuses.

5. The drawn image sharing apparatus according to claim 4, wherein the image supply unit is configured to superpose a marker image for specifying the shared area on the image supplied to the image forming device,
wherein the captured image acquiring unit is configured to delimit the shared area based on the position of the marker image in the image acquired from the image-capturing device.

6. The drawn image sharing apparatus according to claim 4, further comprising:
an image removing unit configured to remove an unwanted image from the image displayed on the drawing object.

7. The drawn image sharing apparatus according to claim 4, further comprising:
an image removing unit configured to remove an unwanted image from the image displayed on the drawing object,
wherein the image removing unit is configured to remove the unwanted image from the image displayed on the drawing object by causing the image transmit unit to transmit an image filled out with a background color of the drawing object.

8. The drawn image sharing apparatus according to claim 4, further comprising:
an image removing unit configured to remove an unwanted image from the image displayed on the drawing object,
wherein the image removing unit is configured to remove the unwanted image from the image displayed on the drawing object at predetermined time intervals.

9. The drawn image sharing apparatus according to claim 4, further comprising:
an image removing unit configured to remove an unwanted image from the image displayed on the drawing object,
wherein the image removing unit is configured to remove the unwanted image from the image displayed on the drawing object depending on a chronological change in at least one of the image captured by the image-capturing device, the image formed by the image forming device, and the difference image generated by the difference image generating unit.

10. The drawn image sharing apparatus according to claim 4, wherein the difference image generating unit is configured to perform a thickening process on the image formed by the image forming device, and then generate the difference image based on the image on which the thickening process has been performed and the image captured by the image-capturing device.

11. The drawn image sharing apparatus according to claim 4, wherein the difference image generating unit includes a filter configured to remove from the generated difference image a color component of at least one of yellow-green and yellow.

12. A drawn image sharing system for allowing images drawn on plural drawing objects to be shared among the drawing objects, in which system a drawn image sharing apparatus is allocated to each drawing object,
wherein the drawn image sharing apparatus comprises:
an image receive unit configured to receive an image transmitted from one or more other drawn image sharing apparatuses;
an image display unit configured to display the image received by the image receive unit on the corresponding drawing object;
a shared area image acquiring unit configured to acquire an image of a shared area of the image displayed on the corresponding drawing object;
a difference image generating unit configured to generate a difference image indicating a difference in the shared area between the image displayed by the image display unit and the image acquired by the shared area image acquiring unit; and
an image transmit unit configured to transmit the difference image to the one or more other drawn image sharing apparatuses.
